(19) United States
(12) Patent Application Publication
(10) Pub. No.: US 2005/0282589 A1
(43) Pub. Date: Dec. 22, 2005

(54) Audio session management system and method for a mobile communication device

(75) Inventor: Ayelet Barneah, Tel-Aviv (IL)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/872,290

(22) Filed: Jun. 17, 2004

(51) Int. Cl. H04M 3/00

(52) U.S. Cl. 455/569.1; 455/41.2; 455/41.3

(57) ABSTRACT

A method of managing audio sessions established with a mobile device, wherein a first audio session is established between a first audio device and the mobile device over a short-range wireless connection, comprising establishing a second audio session between the mobile device and a second audio device over the short-range wireless connection; relaying an audio signal transmitted to the mobile device by way of the first audio session to the second audio session; and disconnecting the first audio session, wherein the audio signal is transmitted to the mobile device by way of the second audio session.

### BACKGROUND

1. Field of Invention

The present invention relates generally to mobile communication services and, more particularly, to a system and method for managing audio sessions between a mobile communication device and audio devices connected to over a short-range communication protocol.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Mobile devices such as cellular phones and personal digital assistants (PDAs) can be equipped with wired or wireless communication ports to connect and communicate with other devices. Some devices, such as conventional headsets, or handsfree kits may connect to a mobile phone by way of cable. More advanced audio devices, however, are equipped with wireless ports having infrared or radio frequency operated interfaces (e.g., Bluetooth) that allow the mobile device to connect and communicate with audio devices within a short range by way of initiating an audio session.

For example, a mobile phone can establish a first audio session with a wireless headset to transmit an audio signal to the wireless headset over a Bluetooth connection. If during the first audio session, the user decides to use a second audio device, such as a handsfree kit, to communicate with the mobile phone, the user must first manually manipulate the mobile phone's user interface menu to disconnect the first audio session. Then, the user must manually establish a new audio session between the mobile device and the second audio device. And, even further, after the new audio session is established, the user will have to rout the audio signal over the new audio session (e.g., from the headset to the handsfree kit).

Performing the above sequence of procedures is rather tedious for a user. Particularly, most currently manufactured mobile phones have limited resources and do not support the means for establishing multiple audio sessions with a plurality of audio devices at the same time. That is, if a handsfree kit is connected to the mobile device by way of a first audio session, then a second audio session cannot be simultaneously established between the mobile device and a wireless headset.

Even if a mobile device is configured to support establishment of multiple concurrent audio sessions, the currently developed mobile devices do not support the means by which a user can switch transmission of an audio stream from a first audio session over to a second audio session. Accordingly, in the above example, even if a user is successful in establishing a second audio session between the mobile device and the headset, the user will still have to manually program the mobile device to transfer the audio stream from the first audio session (i.e., handsfree kit) over to the second audio session (i.e., headset), if possible. Otherwise, no audio signal will be transmitted to the headset, over the second audio session.

Thus, a system and method is needed that can overcome the above described shortcomings by way of allowing a user to transparently switch a voice session from a first audio device to a second audio device.

### SUMMARY

The present invention is directed to a system and corresponding methods that facilitate management of audio sessions between a mobile device and one or more audio devices.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method of managing audio sessions established with a mobile communication device is provided, wherein a first audio session is established between a first audio device and the mobile device over a short-range wireless connection. The method comprises establishing a second audio session between the mobile device and a second audio device over the short-range wireless connection; relaying an audio signal transmitted to the mobile device by way of the first audio session to the second audio session; and disconnecting the first audio session, wherein the audio signal is transmitted to the mobile device by way of the second audio session.

The short-range wireless connection is established over a Bluetooth communication protocol. The second audio session is established in response to a first event triggered by a user of the second audio device. The first audio device is at least one of a wireless handsfree communication kit and a wireless headset. The second audio device is at least one of a wireless hands free communication kit and a wireless headset.

In accordance with one embodiment, a system for managing audio sessions established with a mobile device, wherein a first audio session is established between a first audio device and the mobile device over a short-range wireless connection is provided. The system comprises a transceiver for establishing a second audio session between the mobile device and a second audio device over the short-range wireless connection; a router for relaying an audio signal transmitted to the mobile device by way of the first audio session to the second audio session; and a switch disconnecting the first audio session, wherein the audio signal is transmitted to the mobile device by way of the second audio session.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of an exemplary method for switching an audio session from a first audio device connected to a mobile device to a second audio device, in accordance with one embodiment; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for managing transmission of audio signals between a mobile device and one or more audio devices connected to the mobile device.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

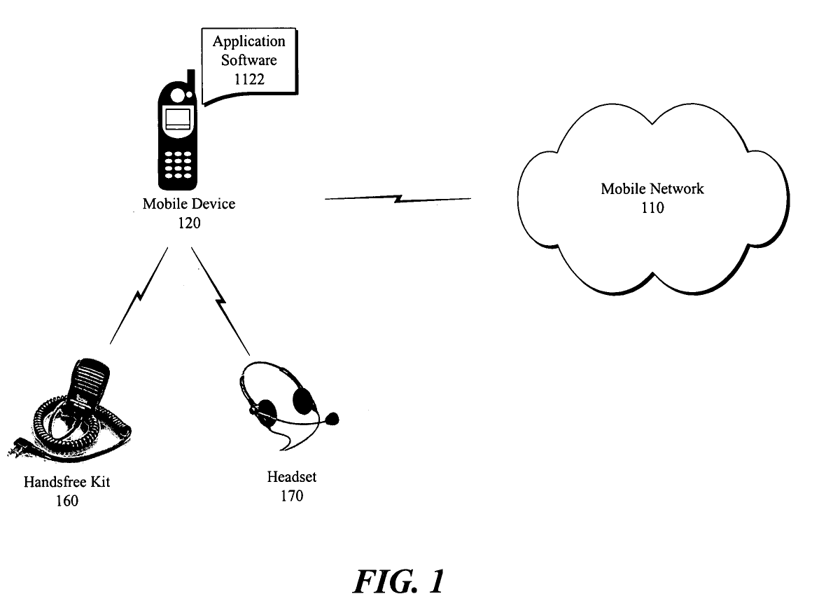

Referring to the drawings, FIG. 1 illustrates an exemplary communication environment in which the system of the present invention may operate. In accordance with one aspect of the invention, the system environment comprises a mobile device 120 that can communicate with one or more audio devices 160, 170 by way of a wireless connection implemented over a well-known wireless communication protocol, such as Bluetooth or IEEE 802.11.

In one embodiment of the invention, the wireless connection between mobile device 120 and audio devices 160, 170 may be implemented over any type of mobile, fixed, wired or wireless communication technology (e.g., landline telephony, cellular, radio, radar, infrared, etc.). The terms “connected,” “coupled,” or any variant thereof, mean any connection or coupling, either direct or indirect, between two or more elements. The coupling or connection between the elements can be physical, logical, or a combination thereof.

In some embodiments, mobile device 120 may be a cordless telephone or a cellular telephone that comprises a personal mobile gateway (PMG) device. Alternatively, mobile device 120 may be a portable communication device configured to communicate with a PMG device for the purpose of establishing a connection with the audio devices 160, 170. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a mobile communication service provider connected in a wide area network (WAN). Thus, the PMG acts as an interface to seamlessly connect a PAN to a WAN. As such the devices attached to the PAN or WAN can communicate with each other. A more detailed description of the PMG architecture is provided in U.S. patent application Ser. No. 09/850,399, filed on May 7, 2001, the entire content of which is hereby incorporated by reference here.

Referring back to FIG. 1, an audio device connected to mobile device 120 may be a headset 160, a handsfree kit 170, or other type of audio device suitable for receiving or transmitting analog or digital audio signals to and from mobile device 120. In certain embodiments, mobile device 120 can be connected to a mobile network 110. Mobile network 110 provides the medium and infrastructure for transmitting digital or analog signals to other mobile devices connected to mobile network 110.

One of ordinary skill in the art will appreciate that mobile network 110 may advantageously be comprised of one or a combination of various types of networks without detracting from the scope of the invention. Such networks can, for example, comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communication network.

In some embodiments, mobile network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can connect to audio devices 160, 170 to send and receive audio signals over a short-range wireless communication protocol, such as Bluetooth, for example. It is noteworthy that embodiments of the invention are described by way of example as applicable to audio sessions established over the Bluetooth communication protocol over which mobile device 120 may communicate with handsfree kit 160 and headset 170. In other embodiments, however, any other type of wireless communication protocol may be utilized to connect any type of wireless device to mobile device 120.

As used herein, the terms mobile device, audio device, and communication network are to be viewed as designations of one or more computing environments that comprise application, client or server software for servicing requests submitted by respective software included in devices or other computing systems connected thereto. These terms are not to be otherwise limiting in any manner.

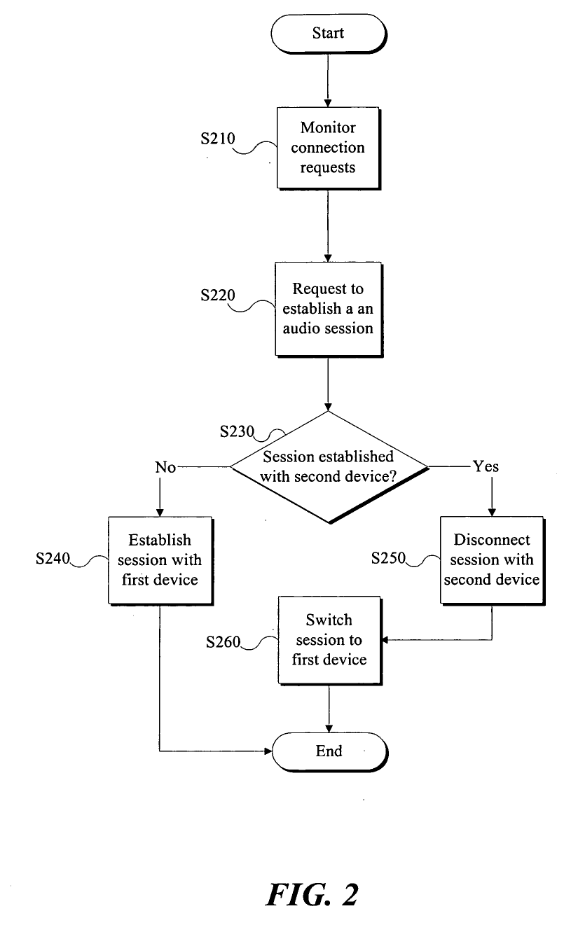

As show in FIGS. 1 and 2, in accordance with one aspect of the invention, application software 1122 or a component thereof is executed on mobile device 120 to monitor requests submitted by an audio device for establishing a connection with mobile device 120 (S210). For example, headset 170 may initiate a request (e.g., SCO request) over the Bluetooth communication protocol to establish an audio session with mobile device 120 (S220). If so, then application software 1122 determines if there is a preexisting audio session established between mobile device 120 and another audio device, such as handsfree kit 160 (S230).

If there are no preexisting audio sessions, then application software 1122 establishes an audio session between mobile device 120 and headset 170 (S240) and begins relaying the respective audio signals between mobile device 120 and headset 170, over the established audio session. Otherwise, if application software 1122 finds a preexisting connection, for example, between mobile device 120 and handsfree kit 160, then application software 1122 disconnects the established session between mobile device 120 and handsfree kit 160 (S250). Thereafter, application software 1122 switches the audio session from handsfree kit 160 to headset 170 (S260) by establishing a new audio session with headset 170 and routing the respective audio signals over the newly established session.

Exemplary embodiments provided herein are not to be construed to limit the scope of the invention to application software 1122 that executes exclusively on mobile device 120, or to a networked environment. Application software 1122 may be implemented on a device or a system other than mobile device 120. For example, application software 1122 or its components may be implemented, installed, and executed either in a singular or in a distributed environment comprising mobile device 120, mobile network 110, a third party portal, handsfree kit 160, headset 170, or other systems attached thereto.

In one or more embodiments, the audio devices (e.g., hands free kit 160, headset 170, etc.) are equipped with an actuator. When the actuator is activated (by way of for example a user pressing a button) then a request for establishing a connection is submitted to mobile device 120. Alternatively, one or more actuators can be implemented on mobile device 120. Thus, for example, when a user presses a particular key on mobile device 120, an audio session is established with a particular audio device. As a result, a user may switch between audio devices by pressing a single button on either mobile device 120 or the audio device.

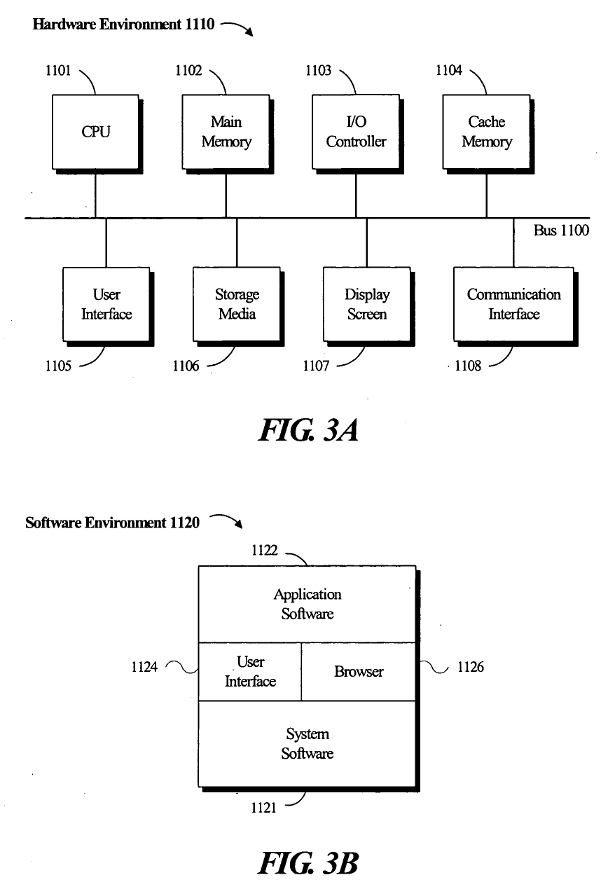

In embodiments of the system, audio devices 160, 170, mobile network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to manage audio sessions between mobile device 120 and audio devices connected to mobile device 120.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock, not shown in FIG. 2A).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile unit 110 may be a PMG phone or equivalent.

In embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Texas Instruments, Qualcomm, Motorola, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1 for example, in one embodiment of the invention, client software is executed on mobile device 120 and server software is executed on network devices 150-170.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate managing communication session established between mobile device 120 and one or more secondary devices. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of managing audio sessions established with a mobile device, wherein a first audio session is established between a first audio device and the mobile device over a short-range wireless connection, the method comprising:
establishing a second audio session between the mobile device and a second audio device over the short-range wireless connection;
relaying an audio signal transmitted to the mobile device by way of the first audio session to the second audio session; and
disconnecting the first audio session, wherein the audio signal is transmitted to the mobile device by way of the second audio session.

2. The method of claim 1, wherein the short-range wireless connection is established over a Bluetooth communication protocol.

3. The method of claim 1, wherein the second audio session is established in response to a first event triggered by a user of the second audio device.

4. The method of claim 1, wherein the first audio device is at least one of a wireless handsfree communication kit and a wireless headset.

5. The method of claim 1, wherein the second audio device is at least one of a wireless handsfree communication kit and a wireless headset.

6. A system for managing audio sessions established with a mobile device, wherein a first audio session is established between a first audio device and the mobile device over a short-range wireless connection, the system comprising:
a transceiver for establishing a second audio session between the mobile device and a second audio device over the short-range wireless connection;
a router for relaying an audio signal transmitted to the mobile device by way of the first audio session to the second audio session; and
a switch disconnecting the first audio session, wherein the audio signal is transmitted to the mobile device by way of the second audio session.

7. The system of claim 6, wherein the short-range wireless connection is established over a Bluetooth communication protocol.

8. The system of claim 1, wherein the second audio session is established in response to a first event triggered by a user of the second audio device.

9. The system of claim 1, wherein the first audio device is at least one of a wireless handsfree communication kit and a wireless headset.

10. The system of claim 1, wherein the second audio device is at least one of a wireless handsfree communication kit and a wireless headset.
